(19) United States
(12) Patent Application Publication
(10) Pub. No.: US 2006/0106796 A1
(43) Pub. Date: May 18, 2006

(54) Knowledge stores for interactive diagnostics

(75) Inventors: Sreedharan Venkataraman, Bangalore (IN); Abhijit K. Upadhyay, Bangalore (IN); Saurabh Jentilal Hansalia, Bangalore (IN); Nayyer M. Iqbal, Bangalore (IN)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Honeywell International Inc.

(21) Appl. No.: 10/990,745

(22) Filed: Nov. 17, 2004

(51) Int. Cl. H04Q 7/20

(52) U.S. Cl. 707/6

(57) ABSTRACT

Knowledge stores, interactive diagnostic services, and interactive diagnostic systems are presented. Symptoms associated with an observed problem are used to mine a knowledge store for questions. Interactive answers to the questions are used to dynamically mine the data store for potential causes and for corrective actions to the problem.

### FIELD OF THE INVENTION

The invention relates to data processing and in particular to techniques for data modeling and analysis.

### BACKGROUND OF THE INVENTION

A variety of equipment, machinery, and devices (resources) are available in the industry. At some point in time over the lifecycle of a resource, that resource will likely experience some sort of failure. One approach to resolve failures is to manually consult an expert/technician; to manually consult maintenance or user manuals associated with a specific resource; or to manually analyze historical data and arrive at a conclusion.

However, technicians are costly and may not be available when a consumer or user experiences a failure and needs an immediate resolution to that failure. Additionally, some resources (e.g., aircraft, computers, vehicles, etc.) may be associated with technical domains where there are a multitude of available reference manuals and where each reference manual may span several thousands of pages. Thus, resource problem resolution is a time-consuming and laborious task.

To make matters worse, many resolutions to failures may be associated with a variety of dependencies related to other portions, instruments, or parts of a resource. The manuals may not be capable of adequately expressing these dependencies in manners that a user can comprehend and can follow in a straightforward manner. Accordingly, there may be situations where some failures are not identified because of dependencies or procedures that cannot be clearly of concisely expressed in manners that a user may comprehend properly.

Moreover, manuals, which are used to resolve a problem, may be geographically dispersed from one another, may be in different types of media from one another, and/or may be in different languages from one another. For, example some manuals may be available on the World-Wide Web (WWW) in electronic format while other manuals may be available in hardcopy format from a manufacturer. Further, even if manuals are available in electronic format, the manuals may not be indexed and therefore will not be searchable. This may occur when a manual is in an imaged format and not in a text format within a machine media. The manuals may also not be in the native language of a user, in which case the manuals will be of little use to the user.

However, there have been some efforts to capture the processes associated with repair and troubleshooting within individual businesses, within service centers, or within manufacturing sites. But, deciphering the information for historical data is quite cumbersome and laborious to mine because of inconsistent data formats.

In fact, certain current diagnostic solutions provide a basic diagnostics model, where the symptom, failure, and repair actions are considered and mapped. Thus, detailed diagnostics, which are represented with complete Failure Mode and Effect Analysis (FMEA) flowcharts and their generic states, alternative paths, and diagnostic aids are often omitted and not integrated with those diagnostic solutions.

Automated diagnostic processing is further complicated when systems include a variety of subsystems and the subsystems include a variety of individual components. As a result, unified diagnostic approaches that might cascade through multiple levels remain largely non-existent and undeveloped because of the complexity associated with the various dependencies and relationships between systems, subsystems, and components.

Generally, there has been some advancement with respect to preventive maintenance. One example is where different types of equipment and their maintenance information was mapped and associated within a database. Similarly, there has been some general improvement in the field of corrective maintenance that aids selecting appropriate action associated with at least one reported cause. However, there has not been an approach that integrates preventative maintenance, corrective maintenance, and automated diagnostics in a single unified approach that accounts for the various relationships and dependencies.

Accordingly, there is a need for improved automated diagnostics that provides an integrated approach that integrates the approaches discussed above.

### SUMMARY OF THE INVENTION

In various embodiments of this invention techniques are provided for interactive resource diagnostics using knowledge stores. The embodiments assist in identifying various diagnostic entities and modeling those entities within knowledge stores for purposes of providing unified and automated interactive resource diagnostics.

More specifically, and in one embodiment, a method for interactively diagnosing a resource is provided. One or more symptoms associated with an observed problem from a resource are received. The symptoms may be received from a plurality of resources or from a single requestor. In response to the one or more symptoms, one or more questions or procedures are posed. Furthermore, in response to the one or more questions or procedures, one or more answers are received. The one or more answers are used to determine a cause of the problem and from the cause one or more corrective actions are derived. Moreover, one or more diagnostic aids, if any, are derived for one or more corrective actions. Additionally, the one or more corrective actions and diagnostic aids, if any, are presented for resolving the problem.

In an embodiment, where a problem is deemed to have multiple causes, one or more clarifying questions are posed after some of the corrective actions are performed. This is done to more completely resolve and to interactively resolve a problem, which has multiple causes.

### BRIEF DESCRIPTION OF THE DRAWINGS

FIG. 1 depicts an entity relationship diagram for an interactive diagnostic data model, according to an example embodiment of the invention.

FIG. 2 depicts an architectural diagram for an interactive diagnostic system using one or more portions of the data model presented in FIG. 1, according to an example embodiment of the invention.

FIG. 3 depicts a diagram of a method for interactively diagnosing a problem, according to another example embodiment of the invention.

FIG. 4 depicts a diagram of another method for interactively diagnosing a problem, according to another example embodiment of the invention.

FIG. 5 depicts a diagram of a knowledge data store that is adapted to facilitate interactive problem resolution, according to an example embodiment of the invention.

FIG. 6 depicts a diagram of an interactive diagnostic system, according to an example embodiment of the invention.

FIG. 7 depicts a diagram of a usage scenario for the techniques presented herein, according to an example embodiment.

### DETAILED DESCRIPTION OF THE INVENTION

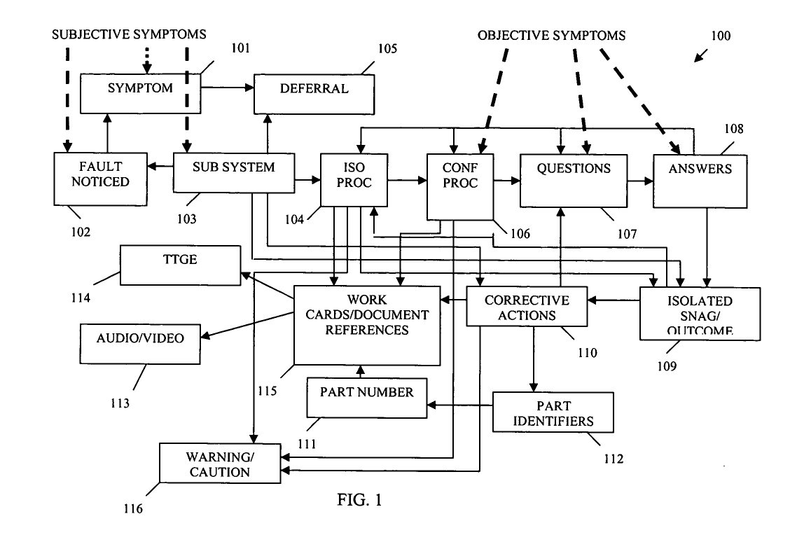

FIG. 1 is an entity relationship diagram for an interactive diagnostic data model 100, according to an example embodiment of the invention. The interactive diagnostic data model 100 is implemented within a machine-accessible and readable medium and is accessible to a variety of services over a network. The network may be hardwired, wireless, or a combination of hardwired and wireless. The data model 100 enables information collection from disparate sources in such a way that the logical relationships and various groupings between entities will enable novel interactive diagnostics; this offers various advantages as will be described in greater detail with various embodiments presented herein.

The interactive diagnostic data model 100 depicts a variety of data entities and some example interactions of those entities. The purpose of the interactive diagnostic data model 100 is to facilitate interactive diagnostics, such that step-by-step advice may be interactively and dynamically supplied to a user. Additionally, the interactive diagnostic data model 100 reduces the dependence on experts, such that even novices can troubleshoot and resolve complicated problems with devices, systems, and/or components. Furthermore, self-learning is promoted, bulky manuals may be reduced, and disparate manuals may be linked and integrated with one another.

The data entities depicted in the interactive diagnostic data model 100 may be logically classified into a variety of groupings. For example, categorical entities provide storage for a set of entities that categorize a fault model with respect to equipment to which primary entities are applicable, a particular fault model's hierarchical information, the key-words used to support entity look-up and the change package data that is used to control the revision of primary entities. Primary entities are diagnostic entities that include information about the troubleshooting. It should be noted that primary entities provide storage for a fault model's description of failure modes associated with a system or a sub-system that is being maintained, provide symptoms associated with the failure modes, and provide any additional data required to minimize the operational impact of a failure and to correct the failure as efficiently as possible.

Some example categorical entities may include, system identifiers, effectivity, thesauri, equipment types, and/or change packages. These categorical entities will now be discussed in greater detail.

A system identifier provides the complete information of chapters or sections associated with manuals or guides for an asset (e.g., resource) from which knowledge is extracted. Some attributes of a system identifier include a unique identifier, a numeric identifier for a system or subsystem task, a title description for the system identifier that is viewed by a user, an identifier for a next higher-level system identifier, a fault model identifier, location references to diagnostic aids, and the like. A variety of other attributes may also be configured into a system identifier.

Effectivity tags allow multiple systems that are the same but have minor differences in configuration to be placed within a same fault model. For example, a corrective action may be applicable to only a particular type/configuration of an asset (e.g., applicable for aircraft having a module number 1228 incorporated, etc.). Some example attributes of effectivity tags may include a unique identifier, range of assets associated with the effectivity tags, title descriptions for the effectivity tags that are viewed by users, fault model identifier, and the like.

Thesaurus contains domain words and their synonyms, which are used in searching the similar records during processing. In addition, a thesaurus may include other statistical information, which might be useful in processing. Some example attributes may include domain words and their synonyms.

A fault model includes an entity that records the relationship between words and abbreviations that are used synonymously in the maintenance environment. These entities are linked to various elements of the fault model in order to support a smart search function that allows the user to enter a description of the item they need using words that may or may not match the words used to name the corresponding fault model items. Some of their attributes include a word or phrase used in text lookups, lists of equivalent thesaurus entries, identifiers for a change package, and the like.

An equipment type contains information about various asset fault model types. Some example attributes may include a unique identifier, title descriptions for the fault model, and the like.

A change package permits versioning. That is, a fault mode includes information that allows each of its items to track its deviation from source data or track its creation by particular authors. This information allows elements to be modified in their source location (e.g., a technical manual) and have those changes automatically propagate into the corresponding items in the fault model while preserving updates and links to those items made in the fault model. The change package permits a mechanism that also allows the personnel that are responsible for the fault model to control the timing of the release of updates to the fault model. Some of the attributes of a change package may include a unique identifier, title description, state of the change package, data and time that the change package becomes active, fault model identifier, and the like.

The interactive diagnostic data model 100 presented in FIG. 1 includes a few example primary entities, such as symptoms 101, fault noticed 102, sub system 103, isolation procedures 104, deferral procedures 105, confirmation procedures 106, questions 107, answers 108, isolated snags/outcomes 109, corrective actions 110, part numbers 111, part identifiers 112, audio/video 113, tools testing, and ground equipments (TTGE) 114, work cards/document references 115, and warnings/cautions 116. A variety of additional primary entities not shown in the interactive diagnostic data model 100 may also be used in various embodiments, such as documents, asset servicing recommendations, and/or asset sub components servicing recommendations. These primary entities will now be discussed in greater detail.

A symptom 101 is an abnormality reported about an asset (e.g., resource) or an indication made about a failure or a deviation from an asset's expected or anticipated behavior (e.g., hydraulic pressure not building up for a non-human asset). Symptoms/observations 101 are users' entry points into a fault model. They include readily available indicators of an observed problem, including warning messages displayed in a computer system, occurrences that were felt or heard, or visible damage to an asset.

The symptoms 101 are observed by users, maintenance personnel, and/or technicians associated with the asset. They are observed without having to analyze the problem and without having to specify other conditions that may be occurring when the symptom 101 is observed. A symptom 101 may also be associated with one or more deferrals or concessions 105 and has a relationship with categorical entities. Some symptom 101 attributes include unique identifiers, descriptions of identified symptoms 101, symptom 101 type (may be system generated, observed, or general), level of the symptom 101 (e.g., advisory, caution, etc.), source of the symptom 101 (e.g., from which system is symptom from, etc.), system identifier, fault model identifier, and the like.

A fault noticed 102 is a unique symptom 101 or a unique group of symptoms 101 that identifies a fault or an abnormality. Generally, this may also be referred to as the “problem perceived” by the user. Basically, a fault noticed 102 represents a distinct set of observations that indicate a specific problem within the system (e.g., “gear doors displayed and doors amber light illuminated”). Fault noticed 102 rules are associated with one particular subsystem and has a unique set of symptoms 101 associated with it. A fault noticed 102 also has a relationship with categorical entities. Some attributes of a fault noticed 102 may include a unique identifier, descriptions of the noticed observations, code, system identifier, and/or a fault model identifier.

Subsystems 103 are unique collections of actions that can or may be taken to resolve a particular problem. A subsystem 103 is an end point of fault classification and it is an entry point into a fault isolation process. Multiple faults noticed 102 might lead to the same subsystem 103. This assists in identification of quick solutions. In other words, a subsystem 103 is associated with all known procedures that have the possibility of fixing the problem in the system (i.e., a subsystem 103 can also be associated with one or more deferral procedures 105 that can defer repairs on the subsystem 103 until a later desired time). A subsystem 103 can also be associated with isolation procedures 104, which can be used to reduce the list of repairs down to one specific repair. Moreover, a subsystem 103 can also be associated with one or more repair procedures that solve a problem. A subsystem 103 is also associated with an isolated snag 109 and has a relationship with categorical entities. Some example attributes of a subsystem 103 may include a unique identifier, a subsystem 103 description, a system identifier, and/or a fault model identifier.

The process of moving from a symptom 101 reported to the identification of a subsystem 103 is referred to as fault classification. A questionnaire that aids in the collection of multiple symptoms 101 from a user is also referred to as subjective symptoms 101 as they represent the subjective description of the fault noticed 102 or malfunctions in an asset perceived by a user.

An isolation procedure 104 is the procedure that is carried out to find the exact cause of the problem in the asset from other possible causes which may exist based on the fault noticed 102. An isolation procedure 104 includes confirmation procedures 106, questions 107, answers 108, an isolated snag 109, and/or corrective actions 110. Each isolation procedure 104 may be associated with one or more subsystems 103. An isolation procedure 104 is also associated with one or more isolated snags/outcomes 109, which indicate the result of testing inside the isolation procedure 104.

Additionally, an isolation procedure 104 may also be linked to many outcomes indicating that different isolation procedures 104 are references to the current isolation procedure 104 as the next step in troubleshooting the problem in the asset. An isolation procedure 104 may have one or more document references associated with it. An isolation procedure 104 is also associated with one or more confirmation procedures 106 and may be associated with one or more warnings/cautions. The isolation procedure 104 has a relationship to categorical entities and some example attributes may include a unique identifier, description, and/or a fault model identifier.

A deferral procedure/concession 105 is a procedure that enables the continued operation, under some possible restrictions, of a system without fixing the problem in the system. A deferral procedure 105 lists the action to be done before deferring the problem or instructing whether or not the problem can be deferred. Deferral procedures 105 are associated with an observation and/or a subsystem 103. Typically, a deferral procedure 105 is associated with a document reference; it has a relationship to categorical entities; and some example attributes may include a unique identifier, description, and/or a fault model identifier.

Confirmation procedures 106 are any procedures that assist in finding the root causes of problems (e.g. “perform the hydraulic level contamination test”). A confirmation procedure 106 is associated with a single question 107. A confirmation procedure 106 may have one or more document references associated with it; it may be associated with one or more warnings/cautions; it has relationships to the categorical entities; and some example attributes may include a unique identifier, description, and/or a fault model identifier.

A question 107 is any important information that an expert would know to ask in order to reach conclusions while diagnosing a problem with an asset or system (e.g., “what was the level of contamination within the hydraulic fluid?”). A question 107 is associated with one or more answers 108; it has a relationship with categorical entities (e.g., change package, thesauri, and equipment type); and some example attributes may include a unique identifier, description of the question to be asked to the user for a confirmation procedure 106, system identifier, and/or a fault model identifier.

An answer 108 is an outcome of a performed confirmation procedure 106. An answer 108 may lead to different results. The results can other confirmation procedures 106, other questions 107, and/or an isolated snag 109. In response to an answer 108, there may be another asked question 107 or another confirmation procedure 106 presented; this continues until a decision is reached on a particular isolated snag 109 (e.g., “contamination level is high; contamination level is low; contamination level is okay, etc.”). An answer 108 has relationships to categorical entities, such as change package and equipment type. Additionally, some example attributes of an answer 108 may include a unique identifier, the text description response provided by the user in response to questions 107 for confirmation procedures 106, a system identifier, and/or a fault model identifier.

An isolated snag/outcome 109 is the cause of a failure or cause of a deviation from standard or expected behavior of the asset (e.g., “the cause of hydraulic pressure not building up is the high level of debris in the hydraulic fluid or high contamination level within the hydraulic fluid”). An isolated snag 109 has one or more corrective actions 110 associated with it; has a relationship with categorical entities; and some example attributes include a unique identifier, description for the cause or the abnormality, a system identifier, and/or a fault model identifier.

A corrective action 110 is a specific action used to resolve a problem or a part of the problem within a system or asset. This is the action taken to restore the system or asset to a healthy and functioning state (e.g., “replenish and replace the hydraulic fluid with a clean fluid and carry out the hydraulic system checks). A corrective action 110 may be associated with one or more of each of the following: isolated snags/outcomes 110, part identifiers, document references, and/or warnings/cautions. A corrective action 110 has relationships to categorical entities and some example attributes may include a unique identifier, an action to be done to correct the problem, a system identifier, and/or a fault model identifier.

The process of moving from a subsystem 103 to the identification of one or more corrective actions 110 is referred to as fault isolation. A questionnaire that aids in detailed troubleshooting through various confirmation procedures 106 may also referred to as objective symptoms, since this provides the user an environment for collecting data through objective questions.

A warning/caution 116 lists any prerequisites or warnings/cautions 116 associated with procedures like isolation procedures 104, repair procedures, and/or confirmation procedures 106. Ignoring information presented from this entity may result in damage to personnel or to the asset. A warning/caution 116 has a relationship to categorical entities, such as change package and system identifier; and some example attributes include a unique identifier, description, type information (prerequisites, warnings, cautions, etc.), and/or level (hazardous, advisory, etc.).

Work cards 115 (referred to hereinafter as “document references”) are used to link fault model entities to sections of a document. A document reference 115 may have one or more superceding document references 115. A superceding document reference 115 is one that replaces the prior one in whole. The old or prior document reference 115 should now longer be used when it is superceded. A document reference 115 may have one or more supporting or nested document references 115. A supporting document reference 115 is one that provides additional information in conjunction with the prior document reference 115. A document reference 115 may be associated with TTGEs and audio/video aids 113. A document reference 115 has a relationship with categorical entities and some example attributes include a unique identifier, a title description, a bookmark, a volume, a system identifier, and/or a fault model identifier.

A part identifier 112 is a codified representation of a part in a complex system. A part identifier 112 is associated with one or more part numbers 111 and may be associated with one or more repair procedures. A single part identifier 112 is associated with at least one part number 111. If a part identifier 112 has its own fault model, then that part identifier 112 has a relationship with an equipment type that will facilitate the user in diagnosing a problem on that part identifier; this enables hierarchical diagnostics. A part identifier 112 has a relationship with categorical entities and some example attributes may include a unique identifier, a title description, part identifier text information, a system identifier, and/or a fault model identifier.

Part numbers 112 represent parts that go in locations identified by the part identifiers. The same location can often fit multiple parts. For example, a different manufacturer generally makes each different part for a given location. A given part can also be used in multiple locations within the system. A part has a document reference associated with it; has a relationship with the categorical entities; and some example attributes include a unique identifier, a title description, part number text information, a system identifier, a fault model identifier, and/or other attributes associated with an asset.

TTGE 114 are equipment and tools that may be used for carrying out confirmation procedures 106 or corrective actions 110. The TTGE may include tools, testing and ground handling equipment, and any other special equipment. The TTGE has a relationship to categorical entities and some example attributes include a unique identifier, a title description, a part number 111, a system identifier, and/or a fault model identifier.

An audio/video entity 113 is audio and/or video snippets, which may be played for a user if procedures for performing an isolation and/or repair are complicated. These are aids that have relationships to categorical entities and some example attributes include a unique identifier, a media type, a file location or a file reference, a system identifier, and/or a fault model identifier.

Documents are used to store information about maintenance and operational documents. Document entities record information about how to open the viewer for the document and how to navigate to the various document elements included within the document. Documents are associated with document reference and equipment; have relationships with categorical entities; and some example attributes may include a unique identifier, a title, an invocation routine or service, a location reference, a system identifier, and/or a fault model identifier.

Equipment entities are used to identify top-level assemblies that are maintained by an operator. For example, with an airplane, the aircraft model itself is the entry recorded within the equipment entity. A single fault model governs each equipment entity instance. Equipment information is used to identify effectivity tags that are valid for a given piece of equipment. Equipment entities have relationships with categorical entities and some example attributes may include unique identifiers, title, and equipment identifiers.

Asset servicing recommendations are entities for performing the preventive maintenance on given assets. This stores information about actions to be performed on the asset on periodic bases to keep the asset in a serviceable and operational condition. It has a relationship with categorical entities and document reference entities; and some example attributes may include a unique identifier, periodicity of a maintenance task according to an asset life computation strategy, a description of a task, a system identifier, and/or a fault model identifier.

Asset sub components' servicing recommendation entities store information about the action to be done on an asset's sub components on a periodic basis to keep the asset in a serviceable or operational condition. This is useful because generally when preventative maintenance is performed on an asset sub components are also removed for servicing. This entity has a relationship with the document reference entity and some example attributes may include a unique identifier, part number 111, periodicity of the maintenance task according to asset life computation strategies, description of the task, service type, service limit, system identifier, and/or fault model identifier.

A hierarchical fault model may be achieved with the embodiments presented herein. For example, a part identifier may have a two-way relationship with an equipment type. The first relationship communicates that the part identifier belongs to a certain asset or fault model occurring at a higher level within a hierarchy. The other relationship identifies the particular fault model of the part identifier. For example consider the following tables depicting the hierarchical relationships:

| Equipment Type | Repair Action | Part Identifier |
|---|---|---|
| Aircraft | Repair the Engine | Engine |
| Engine | Repair the Gearbox | Gearbox |
| Gearbox | Repair the Shaft Assemble | |

In the above example, the engine has a relationship with equipment type identified as aircraft (a higher level within the hierarchy) and also has a relationship with Gearbox (a lower level within the hierarchy). The part identifier entity provides the link between the instances of an engine part identifier to the model of that part identifier (model of a specific engine).

The entities and their relationships depicted in FIG. 1 represent knowledge that can be interactively mined and searched for purposes of providing real-time maintenance and interactive diagnostics. The entities may be represented in a data store, such as a relational database. Initially populating the database (knowledge store) can be achieved in a variety of manners.

For example, consider knowledge which is contained within user guides and/or operational manuals and that is available as document entities. The knowledge may be mined automatically from these document entities and populated to a knowledge store. The format of the document entities may vary based on document types. In some document entities just knowledge information is present. In other documents, the knowledge information and the information about the structure of the document is also available.

The structural information can be represented in the knowledge store for the purposes of providing instruction to knowledge extraction services about how the knowledge is to be viewed or encoded within the documents (e.g., Word, etc.), about how information is arranged and segmented within the documents (e.g., schemas, data type definitions (DTDs), etc.); and the like. That document entity may be used by a knowledge extraction service to automatically acquire and assemble the content of a manual or guide and to populate that content as primary and/or categorical entities having relationships similar to what was presented above.

In other embodiments, the above discussed entities (primary and categorical) and their associations and relationships maybe automatically populated to the knowledge store from an existing electronic manual or guide. This may occur when intelligent parsing is used to identify the entities included within an electronic document (e.g., manuals, guides, etc.). The document may be pre-tagged so as to identify its elements (e.g., title, chapter, section, etc.) and these elements assembled and parsed into knowledge store as primary entities or categorical entities (composite and/or hierarchical). In other cases, the document may be manually viewed within a document viewer (e.g., Word, World-Wide Web (WWW) browser, etc.) and as tagged with entity-associated strings. The content of the document may then be automatically parsed or semi-automatically parsed to identify entities and to acquire the appropriate content data embedded within the document for each of the identified entities. The entities and their content data may then be populated within the data store in records and fields and linked together in a hierarchical fashion. Thus, various automated techniques may be implemented to automate the processes of initially populating the knowledge store.

In addition to acquiring knowledge from documents, such as manuals and guides, knowledge may be acquired in the knowledge store and represented as the entities and their relationships in a variety of manners. For example, historical information associated with resources may be acquired and parsed and used to augment the knowledge of the knowledge store. Furthermore, knowledge may be acquired through experience of users and the feedback and observations that they provide when communicating with the knowledge store. Thus, experience can be captured through a variety of feedback interfaces or authoring interfaces that communicate with the knowledge store and its information. In addition, these entities with their latest information may be dynamically processed in order to give the latest information about current learning; that information may be automatically and dynamically published as documents (knowledge to document (K2D)), which are presented to a user or indexed in an electronic library for subsequent retrieval. This may be useful to automate and control various document versions, which are derived readily and directly from a shop floor. Once the above information or desired portions of the above information is identified for a given resource (asset), then records or entries may be populated into the knowledge store. Moreover, interfaces to the knowledge store may be used to acquire, mine, and interactively diagnose problems that may occur with the resource.

In other embodiments, the same knowledge store can be used to add any new fault model of a given resource (asset), to update an existing knowledge store of a given resource, and/or used as a cascaded fault model for a composite resource at any level using the above-mentioned entities and their relationships.

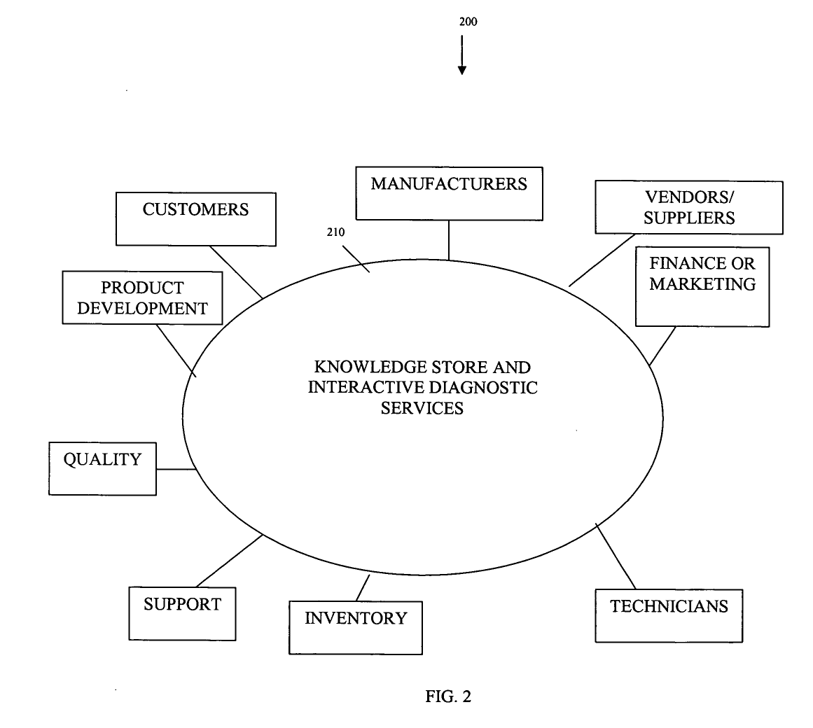

FIG. 2 illustrates an architectural diagram 200 for an interactive diagnostic system, according to an example embodiment of the invention. The architectural diagram 200 is presented for purposes of illustration only and should not be viewed as limiting. Thus, a variety of other components may be added and a variety of other arrangements may be adopted without departing from the embodiments of the invention. The components are implemented as interfaces and services in a machine-accessible and readable medium, which is accessible over a network. The network may be hardwired, wireless, or a combination of hardwired and wireless.

Initially, a knowledge store 210 is constructed and populated with information about resources (assets). A resource is any machine, device, or equipment. In some cases, the device may be logical, such as when the resource is a software system or service. In other cases, the device may be physical, such as when the resource is a processing device. Further, the machine may be a composite device, such as when the resource is an aircraft, spacecraft, vehicle, computer system, etc. Additionally, composite devices may have hierarchical information, where each level of the hierarchy may correspond to a different device, system, subsystem, and/or component of a single device.

The knowledge store 210 structure and entities are similar to what was discussed above with FIG. 1. This structure and its entity relationships facilitate the storage of disparate information into a single centralized logical structure. The knowledge store 210 also includes services or interfaces that permit external components or interfaces to dynamically interact with the knowledge store 210 and its entities in an automated, interactive, and real-time fashion.

The knowledge store 210 may be a single database, a collection of disparate databases organized and interfaced as a single data warehouse, or a logical collection of storage locations (e.g., directories, electronic files, etc.). Additionally, the knowledge store 210 may be implemented as a relational database or as an objected oriented database. The knowledge store 210 may have its own proprietary query interface or may have a conventional database query interface (e.g., SQL, etc.).

One technique for initially populating the knowledge store 210 with the appropriate information about each of the resources is to identify a variety of fields for various predefined entities or to identify types of data that represents the information. Each of these fields for an entity may be indexed, linked to other fields, and has identifiers within the knowledge store. The data or information associated with the entities may be acquired from documents (document to knowledge (D2K)) and/or from historical information (history to knowledge (H2K)). Additionally, the entities and their relationships may be enhanced or modified over the lifecycle of the knowledge store 110 based on experiences with diagnosing problems (experience to knowledge (E2K)).

It should also be noted, that the knowledge store 210 may be used to dynamically add new or modified fault models for assets at any time. Additionally, some fault models may be combined with other fault models to create hierarchical fault models. Moreover, fault models may be dynamically adjusted or updated using entities such as change package, which was discussed above with the description of FIG. 1.

For example, in FIG. 2, the knowledge store 210 and its interfaces are identified as interactive diagnostic system. Initially, the interactions with the interactive diagnostic system may be made from a variety of other external sources or component interfaces (stakeholders) which interface to the interactive diagnostic system. Some example sources are depicted in FIG. 2 as customers, manufacturers, vendors/suppliers, finance/marketing, technicians, inventory, support, quality, and product development.

A sample interaction between the interactive diagnostic system and the external source interfaces may proceed as follows. A stakeholder contacts the interactive diagnostic system with symptoms associated with a problem that is being experienced or observed with a resource (asset). The interactive diagnostic system uses the symptoms to query the knowledge store 210, this results in either an immediate identity of a cause for the problem or specific questions which may assist in narrowing the problem space. The source responds with answers to the questions posed. These answers may lead to confirmation procedures, or may lead to discovery of the cause and thus, corrective actions. Moreover, at any point in time, the interactive diagnostic system may display or present reference material to the source (e.g., text, audio, video, etc.).

As still another operational example, consider that equipment, devices, or resources are used as entities within the knowledge store to represent knowledge associated with top-down assemblies. For example, an aircraft may be defined as a resource or equipment entity. A single fault model governs each equipment, device, or resource. The information associated with the equipment is used to identify effectivity tags, which are considered valid for that equipment. The equipment entities are stored in the knowledge store 210 with a variety of attributes (as described above with FIG. 1). For example, a subsystem, which is an individual entity within the overall fault model, helps in quick troubleshooting and identification of repair. Moreover, each subsystem can be associated with one or more fault codes. Each subsystem is associated with all known repairs, which have the possibility of fixing an observed problem in the system.

Continuing with the present example, a single subsystem can also be associated with one or more deferral procedures that can defer repairs on the subsystem until a later time or upon the happen of some predefined event or condition. Additionally, a subsystem can be associated with isolation procedures, which can be used to reduce the list of repairs down to a specific repair. All relationships between subsystems and systems are represented within the knowledge store 210. In some embodiments, this is achieved as data represented by entities having relationships implemented within relational database tables (as was described in detail above with FIG. 1).

In addition, the knowledge store 210 may have change packages, associated with fault models, which allow each entity to track its deviation from source data (e.g., manuals, guides, etc.) or to track its creation or modification from a specific authoring source (e.g., author or other knowledge source). This tracking of information allows data elements to be changed within their native sources and have those changes automatically propagate throughout the knowledge store 210 and its affected entities via the fault model. Such a mechanism also permits personnel that are responsible for the fault model to control the timing of the release of updates to the fault model. Again, in some embodiments, all these relationships and information may be captured within relational database tables that represent the knowledge store 210.

It should also be noted that the techniques presented herein are not exclusively useful for problem isolation and correction. That is, in some embodiments, the techniques also permit useful techniques for preventative maintenance. For example, a resource's preventative maintenance information and procedures may be acquired, represented, and communicated from the knowledge store 210. In some embodiments, the knowledge store 210 and its interfaces may be designed to automatically send notifications about desired or suggested preventative maintenance for resources.

FIG. 2 is presented as an overview of some features and interactions that embodiments of the invention are capable of. Additional embodiments and features will be more fully described and presented herein and below.

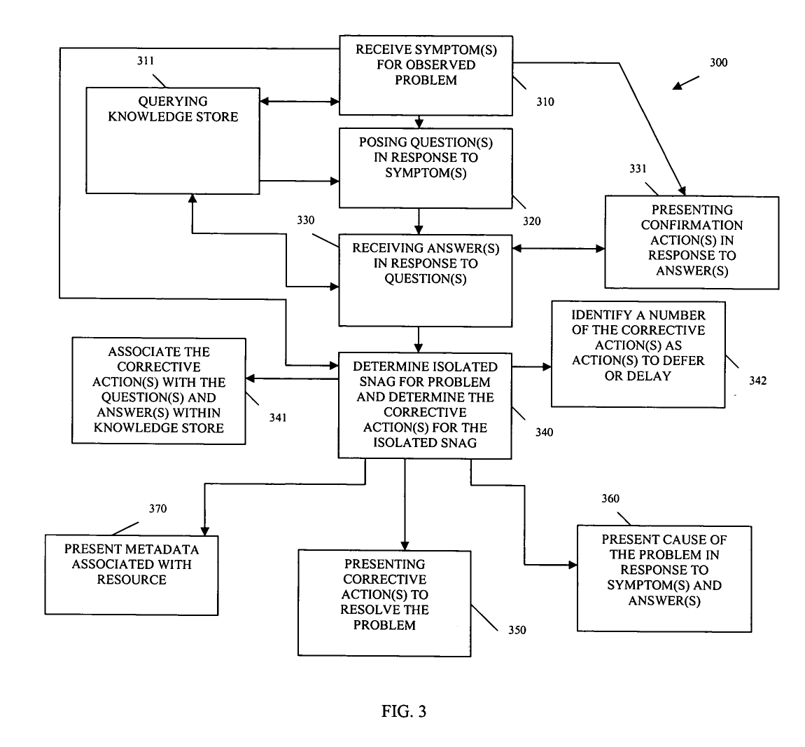

FIG. 3 is a diagram of one method 300 for interactively diagnosing a problem, according to another example embodiment of the invention. The method 300 (hereinafter interactive diagnostic service) is implemented in a machine accessible and readable medium and is accessible over a network. In an embodiment, the interactive diagnostic service implements some of the features and techniques presented above with the interactive diagnostic system of FIG. 2 and the knowledge entities and relationships described in FIG. 1.

Initially, a knowledge store is populated and interfaced to the interactive diagnostic service. The knowledge store includes diagnostic information about one or more resources. Some examples types of information and example relationships between the various types of information were presented above with respect to FIG. 1. Again the one or more resources may be associated with systems, subsystems, or components. The resources may also be modeled as a hierarchy and include a variety of pre-configured relationships and dependencies. Furthermore, resources (assets) may be logically viewed as equipment, systems, devices, and/or subsystems.

At 310, the interactive diagnostic service receives one or more symptoms for an observed problem associated with a resource. The symptoms are received from a variety of sources, entities, or services that are interfaced with the interactive diagnostic service. Some of these sources or stakeholders were presented above with FIG. 2.

In an example embodiment, the symptoms are received from a pilot that interacts with an interface to describe symptoms associated with a problem that he/she is observing with an aircraft (a resource which is modeled as a categorical entity and represented as a system having subsystems and components). In another example embodiment, the symptoms are received from a technician that has a portable communication device which is interfaced to the interactive diagnostic service, where the symptoms are reported by the technician at a remote site in the vicinity of a troubled resource (e.g., machine, device, equipment, etc.). In yet another embodiment, the symptoms are received from a user of a software service, which is the resource, and the symptoms are communicated to the interactive diagnostic service via the Internet using a World-Wide Web (WWW) browser interface. In still another embodiment, the symptoms are received wirelessly from the resource itself as a message, which may be translated for consumption by the interactive diagnostic service or directly consumed by the interactive diagnostic service.

In an embodiment, at 310, once the interactive diagnostic service receives the symptoms, a search query is constructed from the symptoms. This can be achieved in a variety of manners. Thus, the search query may be free text with noise words, or it may be a more intelligent search query that strips noise words, gives more weight to certain search terms, provides morphology enhancements, provides stemming enhancements, provides synonym enhancements, and the like. The search query is used, at 311, to issue a query to a knowledge store. In another embodiment, this does not have to be a search query exclusively; that is, it may be services which are mining algorithms or intelligent routings that process the symptom using free text and that pass on desired information to the knowledge store (hereinafter the algorithms or routines are referred to as a “processor”). The answer set returned from that search query or processor is a set of one or more questions that are directed to more completely narrowing the problem space of the observed problem.

In an embodiment, the interactive diagnostic service may also more efficiently acquire query results from cache. Thus, the interactive diagnostic service may be designed to only ping or contact the knowledge store when results that it desires are not presently available in cache.

It should be noted, that in some instances, the symptoms may be specific or detailed enough such that an immediate cause for the observed problem is detected. In these cases, processing of the interactive diagnostic service may directly pick up at 340, where corrective actions are determined.

If the initial reported symptoms do not immediately identify a cause for the observed problem with the resource, then, at 320, more focused questions are directed back to the initial requester in an effort to narrow the problem space.

At 330, the interactive diagnostic service receives one or more answers from the requestor in response to the posed questions, at 320. In an embodiment, the answers are reduced to a search query and used again, at 311, to query the knowledge store. Furthermore, in an embodiment, at 331, the answers (or the initial reported symptoms at 310) may indicate that some additional testing or information is dictated; correspondingly one or more confirmation actions may be presented to the requester. A requestor performs the confirmation actions and reports them back to the interactive diagnostic service as answers, at 330.

The processing of 310-331 may iterate one or more times until the interactive diagnostic service is capable of identifying a cause for the observed problem with the resource. At such time, at 340, the interactive diagnostic service determines the isolated snag for the problem and then determines the corrective actions that should be taken by the requestor to remedy the identified isolated snag (cause). The interactive diagnostic service may determine the cause by continually interacting with the knowledge store to identify the cause and continually interacting with the requestor to acquire needed information.

It is recognized that what a particular user or resource interface communicates to the interactive diagnostic service is a fault noticed (observed problem). The deduction of a group of symptoms, after a subsystem is identified, from the fault noticed is referred to as fault classification. Identifying corrective actions from the fault classification is referred to as fault isolation or detailed diagnoses. The actual fault is referred to as an isolated snag. Although these terms are not precisely used in the description of the interactive diagnostic system, they are applicable and easily recognized by one of ordinary skill in the art with the various processing depicted in FIG. 3 for the interactive diagnostic service.

In an embodiment, at 341, the interactive diagnostic service may associate new or existing corrective actions with the questions and/or with the answers and then update the knowledge store with these associations. In this manner, the interactive diagnostic service may be capable of learning about problems and problem resolutions for the resource. Moreover, this may reduce future iterations that may have initially occurred with the processing at 310-331 when a similar problem is encountered with a similar resource in the future. It is also noted that the corrective actions are generally always associated with isolated snags. The purpose of associating the questions and answers with corrective actions is that it may permit improved processing throughput for future iterations of the interactive diagnostic service by more quickly determining the corrective actions for certain questions and answers which are known to be associated with a specific isolated snag. Of course, this may not be desired at all in some embodiments, since an isolated snag includes the corrective actions, the isolated snag may be directly associated with the questions and answers and then the corrective actions obtained directly from the resolved isolated snag for a given set of questions and answers.

In another embodiment, at 342, the interactive diagnostic service may determine based on dependencies included in a knowledge store or based on predefined policies that one or more of the corrective actions may or should be delayed or deferred. For example, maybe a corrective action instructs the requester to replace a specific part for the resource and the part has to be ordered or installed by a licensed technician. Alternatively, a corrective action may require performing a procedure on the resource that requires authorization by some one other than the requestor. A variety of different dependencies may result in some corrective actions being deferred, and all such possibilities are intended to fall within the scope of the embodiments presented herein. Additionally, in some cases, the requestor may want to defer some corrective actions. In these cases, at 342, the interactive diagnostic service may inform the requestor whether it is permissible to defer the corrective actions or to still proceed to correct the observed problem in the resource.

At 350, once the cause of the observed problem is isolated and corrective actions determined, the interactive diagnostic service presents the corrective actions to the requester. At this point the requestor performs the corrective actions and the problem is resolved. In an embodiment, at 360, the cause of the observed problem may also be presented along with the corrective actions.

In an embodiment, at 370, the interactive diagnostic service may also present a variety of metadata or supplemental information to the requestor about the resource. For example, the metadata may include configuration parameters associated with the requestor's resource, may include reference material or sections associated with correcting the problem, may include audio/visual guided instructions on how to perform the corrective actions that were presented, and the like.

The techniques of the interactive diagnostic service detail a closed loop interactive diagnostic process. This is significant, because traditional approaches have relied on open loop diagnostics. That is, a closed loop approach asks questions and continues to dynamically interact with a resource's interface or a user's interfaces for purposes of resolving a cause of a problem. An open loop approach simply takes some initial information and then provides a list of possible causes for the problem and relies on the user to ultimately resolve the true cause of the problem. The open loop approach does not dynamically maintain and evaluate a dialogue occurring with the user or a resource's interface as does the techniques of the interactive diagnostic service does.

It should be noted, that the requestor's interface may include a variety of other automated applications that may also be interfaced to the interactive diagnostic service. In this manner, the interactive diagnostic service may directly interact with some of these automated services to acquire answers or to perform automated confirmation actions, etc. In some cases, it may even permit the corrective actions to be performed in an automated manner on behalf of the requestor.

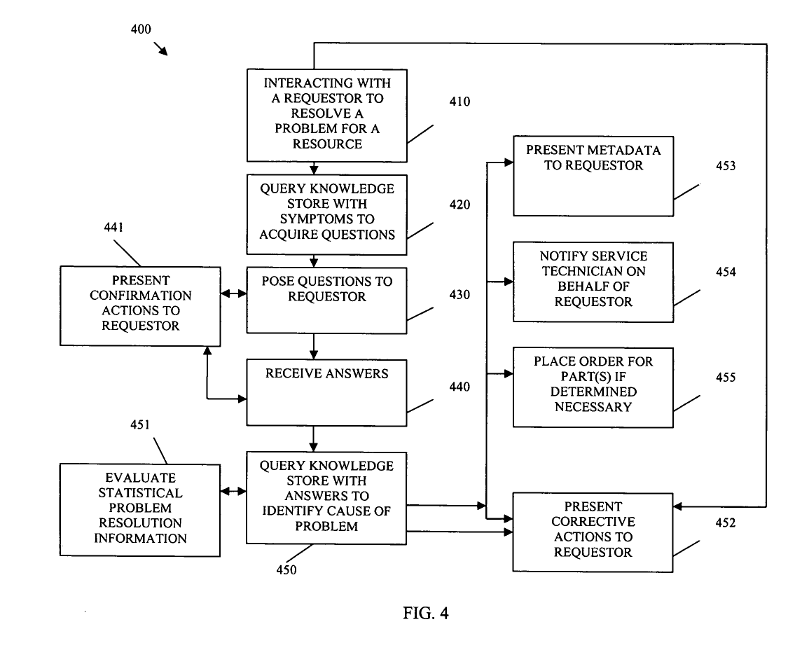

FIG. 4 illustrates a diagram of another method 400 for interactively diagnosing a problem, according to an example embodiment of the invention. The method 400 (hereinafter “processing”) is implemented in a machine-accessible and readable medium and is enabled over a network. The network may be hardwired, wireless, or a combination of hardwired and wireless.

Initially, a knowledge store is created and populated with diagnostic information associated with a plurality of resources. Moreover, the processing is interfaced to Application Programming Interfaces (APIs) of the knowledge store, and the processing is interfaced to a requestor's interface that reports problems associated with resources. Again, the requestor's interface may include a variety of sub-interfaces or services within the environment of the requestor or the environment of a resource of the requestor, which may also interface to the processing. In some cases, the requestor's interface may be an automated interface associated with a resource (e.g., equipment, device, system, subsystem, etc.). In this manner, the processing may interact with a user through a requestor's interface or may interface with a resource's interface.

At 410, the processing and a requester establish communication with one another over a network and interact with one another. The interaction is established by the requestor for the purpose of resolving a problem that is observed with a resource. Initial interaction between the requestor and the processing may include the requestor uniquely identifying the resource with which a problem has been detected. Once the resource's identity is known, the requestor provides the processing with observed symptoms that the resource is experiencing (e.g., failures, data errors, excessive processing time, etc.).

At 420, the processing constructs a search query with the resource's identity and the symptoms and queries the knowledge store with the search query. This may result in an immediate identity of the cause for the problem or may result in a list of candidate causes that require further evaluation. Correspondingly, in some cases, the answer set returned from the knowledge store is a set of one or more questions, which are directed to winnowing the potential causes for the problem down to a smaller set of possibilities or down to a single possibility.

At 430, the questions are posed to the requestor. In some cases, at 441, symptoms may indicate that the processing wants some confirmation actions or tests to be performed by the requestor against the resource in order to further isolate the potential causes. At 440, the processing receives answers from the requestor. Again, the answers may indicate, at 441, that some confirmation actions or tests are desirable.

At 450, the processing constructs a search query or search queries from the answers and queries the knowledge store. In an embodiment, at 451, some answer set information returned from the knowledge store may be statistical problem resolution information or data.

Statistical problem resolution information may indicate probabilities associated with potential candidate causes. These probabilities may be recorded within the knowledge store based on frequencies associated with particular symptoms and/or answers and particular causes that were ultimately determined for their previous problems. In this manner, the processing may provide more than one potential cause to a requester and present the likelihood that each cause is the source of the requestor's problem. Alternatively, if deviations between the potential probabilities are significant (i.e. beyond a predefined threshold value) then the processing may elect to select a particular cause as the source of the problem.

Once the cause of the problem is identified, corrective actions may be presented to the requestor at 452. In various embodiments, the processing may perform a variety of other operations in response to the corrective actions being presented. For example, at 453, the processing may present metadata to the requester, such as reference material, audio/visual guided instructions, configuration information for the resource, and the like.

As another example, at 454, the processing may dynamically and automatically notify a service technician on behalf of the requestor. This may be useful with the procedure associated with the corrective actions dictate that a certified or qualified technician performs the actions. In anther case, at 455, the processing may automatically and dynamically place an order for a part, which was determined necessary with the corrective actions. Moreover, in some instances, the processing may automatically and dynamically interact with services processing in an environment of the requestor to perform some of the corrective actions on behalf of the requestor.

The processing may also be used for purposes of communicating preventive maintenance about a resource. The preventive maintenance may be automatically sent to a requestor or to other sources. For example, a desired preventive maintenance may require scheduling a technician, a service date, and/or ordering parts and in these cases the processing may automatically contact other services to perform schedule or order these items in an automated manner.

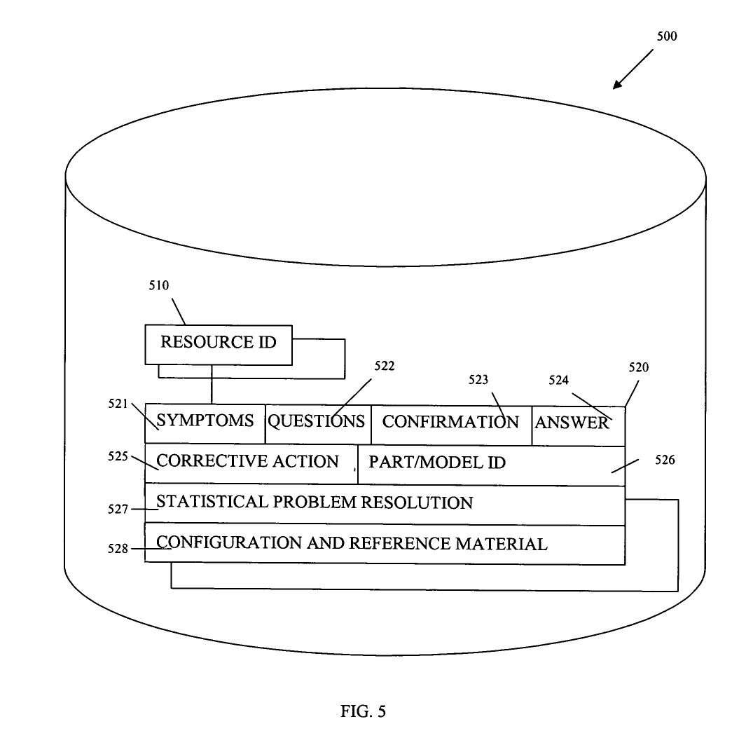

FIG. 5 is a diagram of a knowledge data store 500 that is adapted to facilitate interactive problem resolution, according to an example embodiment of the invention. The knowledge data store 500 is implemented in a machine-accessible or readable medium. The knowledge data store 500 may be implemented entirely within storage, memory, or removable media. Alternatively, the knowledge data store 500 may be implemented in combinations of storage, memory, and/or removable media. In an embodiment, the methods 300 and 400 of FIGS. 3 and 4 utilize and interact with the knowledge data store 500.

The knowledge data store 500 includes one or more resource identification (categorical) entities 510 and a diagnostic entity 520 for each unique resource identification entity 510. The diagnostic entity 520 includes a symptom entity 521, a question entity 522, a confirmation action entity 523, and answer entity 524, and a corrective action entity 525. In some embodiments, the diagnostic entity 520 may also include a variety of other entities, such as a part/model identification entity 526, a statistical problem resolution entity 527, and/or a configuration and reference material entity 528. The diagnostic entity 520 may be viewed as a plurality of primary entities associated in a selective manner to represent knowledge about its categorical entity (resource identification 510).

Each resource identification entity 510 is adapted to be associated with a unique resource identification value for a specific resource included within the knowledge data store 500. The symptom entities 521 are adapted to house symptom information for problems associated with a specific resource. The symptom information may be mined from maintenance and/or user guides for the specific resource and may be acquired from requestors that report symptoms for the specific resource over the lifecycle of the resource. The symptom entities 521 and procedure entities 523 may be linked or associated with question entities 522, fault noticed entities, isolated snag entities, and/or confirmation entities 523, and/or corrective action entities 525.

The question entities 522 are adapted to house questions that are linked to specific symptom information or symptom entities 521 or procedure entities 523 or procedure information. Thus, when symptom information is received from a requestor, the information can be searched within the knowledge data store 500 to acquire related questions contained in the question entities 522 or symptom entity 521. The question entities 522 and confirmation procedure entities 523 may be linked or associated with symptom entities 521 and/or answer entities 524.

The confirmation entities 523 are adapted to house actions or tests to confirm or deny suspected causes of a potential problem. The confirmation entities 523 may be linked and associated with symptom entities 521, question entities 522, and/or answer entities 524.

The answer entities 520 are adapted to house answers provided from a requestor to questions or to confirmation actions or tests. The answer entities 520 may be linked and associated with confirmation entities 523, isolated snag entities, and corrective action entities 524.

The corrective action entities 525 is adapted to house corrective actions or procedures that are to be taken to resolve a specific identified cause of an identified problem. The corrective action entities 525 may be linked or associated with the symptom entities 521, the confirmation action entities 523, and/or answer entities 524.

In an embodiment, the part/model identification entities 526 are adapted to house model and part or component identity information for specific resource identification. The part/model identification entities 526 may permit the diagnostic entity 520 to be replicated a number of times for a single resource identification entity 510, such that a single resource identification value has multiple diagnostic entities 520 within the knowledge store 500, where each diagnostic entity 520 is unique past on specific unique part/model identification values.

In another embodiment, the statistical problem resolution entities 527 are adapted to house relationships, frequencies, and/or probabilities that link specific symptoms and/or answers to corrective actions. For example, if a particular symptom for a resource resulted in a particular set of corrective actions 8 times and a different set of corrective actions 2 times, then the statistical problem resolution entity for the particular symptom may house an 80% probability for the particular set of corrective actions and a 20% probability for the different set of corrective actions. The probabilities themselves may be stored in the statistical problem resolution entities 527 or the frequency counts and/or relationships may be stored and computed separately.

In an embodiment, the configuration and reference material entities 528 are adapted to house metadata about a resource and/or about specific causes for problems of that resource. For example, configuration settings, audio/visual guided instruction material, textual information associated reference manuals, preventative maintenance information, and the like may be stored in the configuration and reference material entities 528. It should also be noted, that this entity may house only a reference or link to an application, service, or to data that contains the configuration or reference material.

In an embodiment, the knowledge data store 500 may also house any, all, or combinations of the data types described above with FIG. 1. Additionally, the knowledge data store 500 may be a relational database or an object oriented database. Further, the knowledge data store 500 may be a single database, or a collection of disparate databases, electronic files, and/or directories interfaced together as a data warehouse. Still further, the knowledge data store 500 may be centralized on a network in a single location or distributed across a network and interfaced together as a single logical data store.

In still other embodiments, the knowledge data store 500 includes a variety of other entities, such as the entities discussed above with respect to FIG. 1. One such example, entity is represented as change package information that permits changes to knowledge sources to be linked to fault models and automatically updated in the knowledge store 400 when updates are detected.

In another embodiment, the knowledge data store 500 may be implemented with in an extensible markup language (XML) and expressed using a schema that is an XML schema definition (referred to as XSD). In this manner, the knowledge data store 500 may communicate its schema in automated transaction with other services and/or data stores to integrate and interface in an automated fashion.

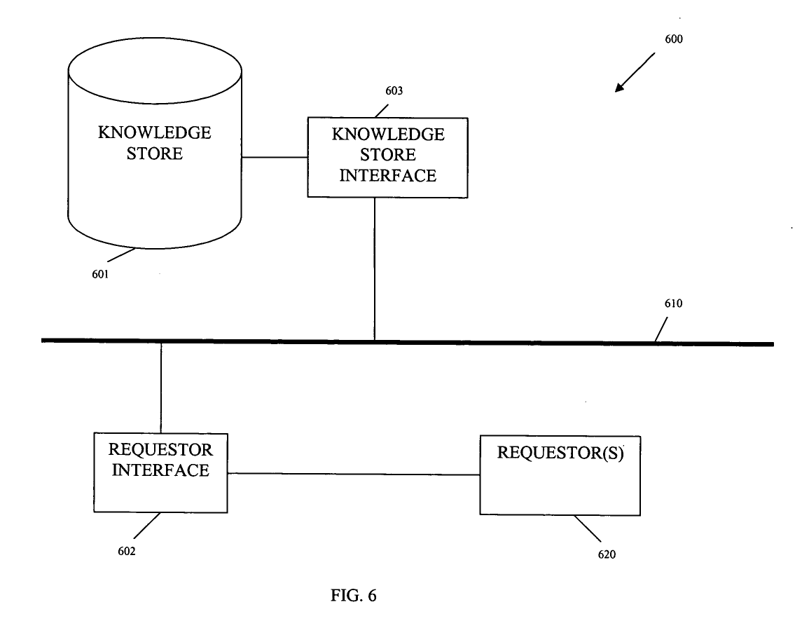

FIG. 6 depicts a diagram of one interactive diagnostic system 600, according to an example embodiment of the invention. The interactive diagnostic system 600 is implemented in a machine-accessible and readable medium and is accessible over any network configuration. The interactive diagnostic system 600 may be implemented in hardware, software, or combinations of hardware and software. In an embodiment, the interactive diagnostic system 600 implements, among other things, the methods 300 and 400 of FIGS. 3 and 4, and uses the knowledge data store 500 of FIG. 5.

The interactive diagnostic system 600 includes a knowledge store 601, a requestor interface 602, and a knowledge store interface 603. The components of the interactive diagnostic system 600 are interfaced over a network 610 to one or more requesters 620 via the requestor interface 602.

The requestor interface 602 is adapted to communicate, over the network 610, symptoms of a problem associated with a resource (equipment, system, subsystem, device, etc.) to the knowledge store interface 603. The knowledge store interface 603 is adapted to query the knowledge store 601 to acquire questions that reduce the potential problem space for an observed problem using a dynamic, interactive, and closed loop approach. The knowledge store interface 603 is further adapted to communicate the questions over the network 610 to the requestor interface 602.

The requestor interface 602 is adapted to interact with the requestor 620 to acquire answers to the questions and to communicate the answers back over the network 610 to the knowledge store interface 603. The knowledge store interface 603 is adapted to query the knowledge store 601 for purposes of acquiring corrective actions and to isolate a cause for the observed problem associated with the resource. Moreover, the knowledge store interface 603 is adapted to communicate the corrective actions to the requestor interface 602 over the network 610. The requestor interface 602 is further adapted to communicate the corrective actions to the requestor 620.

In an embodiment, the knowledge store 601 is remotely located over the network 610 from either the requestor interface 602 or the knowledge store interface 603. In another embodiment, the knowledge store 601 is remotely located over the network from both the requestor interface 602 and the knowledge store interface 603 (not shown in FIG. 6).

In an embodiment, the knowledge store interface 603 is implemented as a service that is accessible over the network 610 to the requestor interface 602. Moreover, in an embodiment, the resource associated with the requestor 620 may be a physical machine, a composite machine, or a logical machine (a software service or system).

In other arrangements, the knowledge store 601 may also include reference materials, configuration information, preventative maintenance information, statistical problem resolution information or data, and/or confirmation actions or tests. The knowledge store interface 602 is adapted to mine the knowledge store 601 for this information via queries and to selectively communicate the information to the requestor interface 602 over the network 610.

In still other embodiments, the knowledge store 601 includes interfaces to a variety of other service that permit knowledge about resources to be acquired, learned, and managed within the knowledge store 601. Thus, authoring interfaces may be used to capture E2K and interfaces may be used to automatically acquire D2K or H2K.

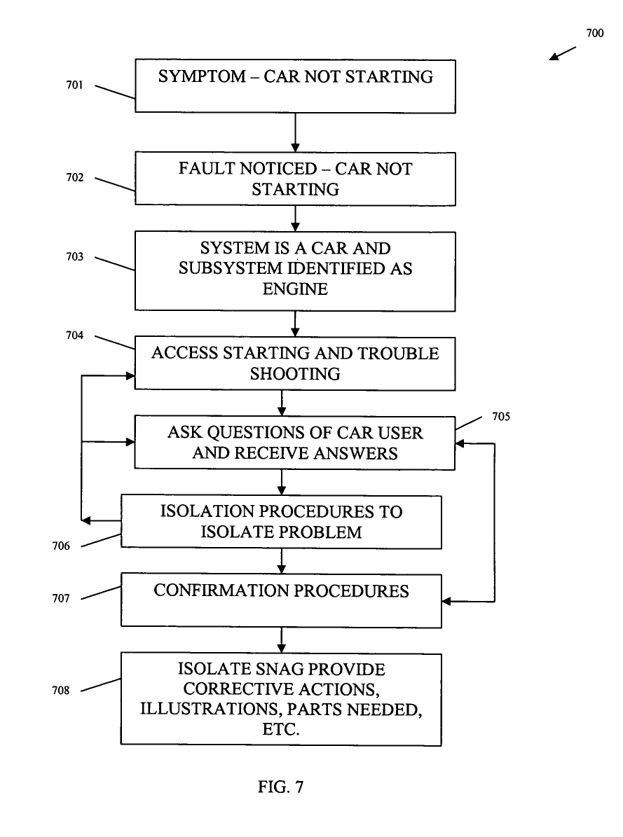

FIG. 7 is an illustration of one sample usage scenario 700 associated with the methods, data stores, and systems presented herein. FIG. 7 is presented to provide an example situation where the techniques presented herein are usefully deployed. The specific usage scenario 700 depicted is not intended to limit the embodiments of the invention in any manner.

FIG. 7 depicts a car problem usage scenario 700. At 701, the car user communicates that the car will not start. The observed problem is car not starting, thus, at 702, the fault noticed is car not starting. The system or resource is a car and based on the fault noticed, at 703, the subsystem of the car is identified as a dealing with starting and troubleshooting.

At 704, a knowledge store is accessed to acquire the fault model for starting and troubleshooting. At this point, the user interacts with the interactive diagnostic service, such as the one depicted in method 300 of FIG. 3 and indirectly with the knowledge store, such as the one depicted as knowledge store 500 of FIG. 5. The interaction is a dynamic and closed loop approach between the interactive diagnostic service and the user.

Correspondingly, at 705, the interactive diagnostic service asks questions of the user and receives answers. At 706, the questions and answers are used to interact with the knowledge store to acquire isolation procedures. Moreover, at 707, one or more confirmation procedures may be communicated to the user. Finally, at 608, an isolated snag is provided to the user along with a variety of other information, such as, but not limited to, corrective actions needed, illustrations, parts needed, etc.

The methods, architecture, data stores, and systems presented herein facilitate usage scenarios similar to the car usage scenario 700 of FIG. 7. As some other examples of usage scenarios consider medical treatment, aircraft diagnosis, software diagnosis, etc. In fact, any resource (human, physical, or logical), system, device, and/or component may benefit from the methods, architecture, data stores, and systems presented herein, where closed loop, dynamic, and interactive diagnosis is performed for purposes of problem resolution and corrective actions. Additionally, the techniques presented herein may be used for purposes of identifying and communicating preventative maintenance for a resource.

The above description is illustrative, and not restrictive. Many other embodiments will be apparent to those of skill in the art upon reviewing the above description. The scope of embodiments of the invention should therefore be determined with reference to the appended claims, along with the full scope of equivalents to which interpreted as reflecting an intention that the claimed embodiments of the invention have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

The Abstract is provided to comply with 37 C.F.R. §1.72(b) in order to allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting an intention that the claimed embodiments of the invention have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

What is claimed is:

1. A data store, implemented in a machine-accessible and readable medium, comprising:
resource identification entities, wherein each resource identification entity is associated with a resource; and
diagnostic entities, wherein each resource identification entity is associated with one or more of the diagnostic entities;
wherein each diagnostic entity includes information for symptoms and actions associated with a particular resource, and the particular resource is identified by one of the resource identification entities, and wherein the diagnostic entities are adapted to facilitate interactive diagnostics.

2. The data store of claim 1, further comprising preventative maintenance information associated with each of the resources.

3. The data store of claim 1, further comprising instructional information associated with portions of the actions within each of the diagnostic entities.

4. The data store of claim 1, wherein the symptoms are represented as system entities and the actions are represented as at least one of confirmation procedure entities, isolation procedure entities, and corrective action entities.

5. The data store of claim 4, wherein each diagnostic entity also includes at least one of question entities, answer entities, deferral entities, work card/document entities, isolated snag entities, subsystem entities, audio/video entities, warning/caution entities, part number entities, part identifier entities, fault noticed entities, tool entities, and equipment entities.

6. The data store of claim 5, wherein the symptom entities, the fault noticed entities, and the subsystem entities are logically associated as subjective entities.

7. The data store of claim 5, wherein the confirmation procedure entities, the question entities, and the answer entities are logically associated as objective entities.

8. A data store, implemented in a machine-accessible and readable medium, comprising:
resource identification entities; and
diagnostic entity for each resource identification entity;
wherein each diagnostic entity includes:
symptom entities;
question entities;
confirmation entities;
answer entities; and
corrective action entities; and
wherein each resource identification entity is adapted to be associated with a unique resource identifier value, the symptom entities are adapted to house symptom information for problems associated with a resource, the question entities are adapted to house questions based on symptom information, the confirmation entities are adapted to house actions to confirm or deny suspected causes of a potential problem, the answer entities are adapted to house answers provided to the questions, and the corrective action entities are adapted to house corrective actions to take with the resource in response to an identified problem associated with the resource.

9. The data store of claim 8, further comprising at least one of a part, unit, and model identifier associated with each diagnostic entity.

10. The data store of claim 8 further comprising, statistical problem resolution entities associated with at least one of the symptom entities, the question entities, the confirmation entities, the answer entities, and the corrective action entities.

11. The data store of claim 8, further comprising at least one of configuration, maintenance, and reference material entities associated with each diagnostic entity.

12. The data store of claim 8, wherein the data store is at least one of a single database and a collection of databases organized as a data warehouse.

13. The data store of claim 8, wherein the data store is implemented as at least one of a relational database and an object oriented database.

14. The data store of claim 8, wherein the resource identification entities and their diagnostic entities are organized in a hierarchical structure.

15. A data store, comprising:
a plurality of primary entities adapted to provide fault model information for a complex system, and adapted to select a particular fault model and wherein the primary entities include symptoms and corrective actions which are adapted to diagnose and remedy problems experienced with the complex system;
a first categorical entity adapted to correspond to the complex system and adapted to select and identify the particular fault model;
a second categorical entity adapted to define logical relationships between the plurality of primary entities/diagnostic entities, and the particular fault model; and
an interface adapted to communicate with the data store in order to provide a fault noticed with the complex system and further adapted to communicate one or more of the corrective actions mined from the data store.

16. The data store of claim 15, wherein the interface is adapted to dynamically and automatically communicate with an interface of the complex system.

17. The data store of claim 15, wherein the data store is a relational database.

18. The data store of claim 15, wherein the entities of the data store are hierarchically arranged within the data store on various different levels of abstraction.

19. The data store of claim 15, wherein the interface is adapted to communicate with an interactive diagnostic service that interfaces with a requestor associated with the complex system.

20. The data store of claim 15, wherein the values and relationships between the entities are adapted to be automatically populated to the data store by at least one of a document to knowledge service, a history to knowledge service, an experience to knowledge service, and a data population service.

21. A method, comprising:
receiving one or more symptoms observed for a problem;
posing one or more questions or procedures in response to the one or more symptoms;
receiving one or more answers to the one or more questions;
determining one or more corrective actions in response to the one or more answers after a cause is determined; and
presenting the one or more correction actions to resolve the problem.

22. The method of claim 21, wherein determining further includes posing one or more additional questions if one or more additional causes for the problem are detected in order to determine the cause.

23. The method of claim 21 further comprising, presenting one or more confirmation actions in response to the one or more answers before determining the one or more corrective actions.

24. The method of claim 21 further comprising, identifying a number of the corrective actions as actions that are to be delayed or deferred until one or more predefined dependencies or events are met.

25. The method of claim 21 further comprising, presenting metadata associated with a resource that is experiencing the problem, wherein the metadata is associated with at least one of configuration settings, reference manuals, and reference articles.

26. The method of claim 21 further comprising, presenting a cause for the problem in response to the one or more symptoms and the one or more answers received in response to the one or more questions.

27. The method of claim 26, wherein determining further includes querying a knowledge store with the one or more symptoms and the one or more answers in order to acquire the one or more corrective actions for the problem.

28. The method of claim 27 further comprising, associating the one or more corrective actions with the one or more questions and one or more answers within the knowledge store.

29. A method, comprising:
interacting with a requestor to resolve a problem observed with a resource;
querying a knowledge store with symptoms provided by the requestor in order to identify questions which are presented to the requestor;
querying the knowledge store with answers received from the requestor in response to questions in order to isolate a cause for the problem; and
presenting the requestor with corrective actions for correcting the problem observed with the resource.

30. The method of claim 29 further comprising, presenting the requester with confirmation actions to confirm or deny potential candidate causes, which may be associated with the problem.

31. The method of claim 30 further comprising, evaluating statistical problem resolution information housed in the knowledge store to assist in identifying the cause of the problem.

32. The method of claim 30 further comprising, notifying a service technician after presenting the corrective actions, if the corrective actions dictate using the service technician.

33. The method of claim 32 further comprising, placing an order on behalf of the requestor for one or more parts associated with the resource if the corrective actions dictate replacement parts.

34. The method of claim 29 further comprising, presenting metadata to the requestor about the resource, wherein the metadata is related to the cause and the corrective actions.

35. The method of claim 29 further comprising, presenting metadata to the requestor about the resource, wherein the metadata is related to preventative maintenance associated with the resource.

36. The method of claim 29 further comprising, processing the method as a closed-loop interactive diagnostic technique.

37. The method of claim 29 further comprising, assembling selective information from the knowledge store for the problem and structuring the selective information as an electronic document for subsequent presentation or retrieval.

38. The method of claim 29 wherein interacting with the requestor further includes interacting with the requestor through wireless communications.

39. A system, comprising:
a knowledge store;
a requester interface; and
a knowledge store interface, wherein the requestor interface is adapted to communicate symptoms of a problem associated with a resource to the knowledge store interface, and the knowledge store interface is adapted to query the knowledge store to acquire questions related to the symptoms and to acquire answers from the requester interface in response to the questions, and the knowledge store interface is further adapted to query the knowledge store with the answers to acquire corrective actions for an identified cause of the problem and to communicate the corrective actions to the requestor interface.

40. The system of claim 39, wherein the knowledge store is remotely located over a network and is remote from at least one of the requester interface and the knowledge store interface.

41. The system of claim 39, wherein the knowledge store interface is implemented as a service accessible over a network to the requestor interface.

42. The system of claim 39, wherein the resource is at least one of a physical machine and a logical machine.

43. The system of claim 39, wherein the knowledge store includes reference materials or preventative maintenance materials associated with the resource, and wherein the knowledge store interface is adapted to communicate selective portions of the reference or preventative maintenance materials to the requestor interface.

44. The system of claim 39, wherein the knowledge store includes statistical problem resolution data associated with known and resolved prior problems with the resource, and wherein the knowledge interface is adapted to process the statistical problem resolution data in order to resolve the corrective actions.
